(19) United States
(12) Patent Application Publication
(10) Pub. No.: US 2007/0246113 A1
(43) Pub. Date: Oct. 25, 2007

(54) First flush passive flow control valve

(75) Inventor: Spiros G. Raftis, Pittsburgh, PA (US)

Correspondence Address: THE WEBB LAW FIRM, P.C., 700 KOPPERS BUILDING, 436 SEVENTH AVENUE, PITTSBURGH, PA, 15219, US

(73) Assignee: Red Valve Company, Inc., Carnegie, PA (US)

(21) Appl. No.: 11/788,781

(22) Filed: Apr. 20, 2007

Related U.S. Application Data
(60) Provisional application No. 60/793,993, filed on Apr. 21, 2006.

(51) Int. Cl. F16N 27/00

(52) U.S. Cl. 138/41; 138/44

(57) ABSTRACT

A passive flow control valve including a barrier member adapted to attach to a fluid conduit. The barrier member defining an upper portion, a lower portion and an intermediate portion depending from the upper portion and the lower portion. The lower portion and the upper portion each defining an opening therein for allowing fluid to pass therethrough. The intermediate portion defining at least one orifice defined therein, wherein the orifice is configured to allow substantially controlled fluid flow therethrough. The flow control valve may also include a passive arrangement for collecting floatables discharged from a pipe.

### CROSS REFERENCE TO RELATED APPLICATIONS

This application claims the benefit of U.S. Provisional Application No. 60/793,993 entitled “FIRST FLUSH PASSIVE FLOW CONTROL VALVE” filed on Apr. 21, 2006, which is hereby incorporated by reference.

### BACKGROUND OF THE INVENTION

1. Field of the Invention

The present invention relates generally to flow control valves, and in particular, to flow control valves used to control stormwater, irrigation water or the like.

2. Description of Related Art

The present invention describes significant improvements to a prior art Passive Flow Control Valve as described in U.S. Pat. No. 6,561,225, which is hereby incorporated by reference. In many municipalities, heavy downpours of rain often result in street flooding and sewage treatment plant overload. The sewage treatment plants could be overloaded or flooded by short duration, heavy rainfall. During this rainfall, valves or gates must be closed, either partially or fully, to limit the flow of water into the processing plant. The flow restriction “backs up” the water in the upstream piping or drainage ditch. When the heavy rainfall subsides, this stored water is released under controlled conditions, by adjusting the valves or gates to achieve the desired, restricted flow. However, conventional methods of controlling stormwater influent typically use valves or gates that require an external energy source to operate. For example, these valves or gates may be manual, electric, pneumatic or hydraulic.

Also, in many municipalities, storm water is typically conveyed through storm sewer piping and discharged directly into a local receiving body of water, such as a stream, river, lake or ocean shore. Floatable debris, such as plastic bottles, STYROFOAM® cups and other buoyant trash are carried along by the storm water. These objects, commonly known as “floatables”, float around in the receiving body of water causing both the perception and reality of an esthetically polluted river, stream, lake or other body of water. Prior art methods of restraining the passage of floatables use screens or grates placed over an end of a pipe to prevent the discharge of floatables into a receiving body of water. However, these screens soon become blocked with the floatables thereby significantly reducing the outflow capacity of the pipe.

It is, therefore, an object of the present invention to provide first flush passive control of high flow fluids, such as stormwater runoff, requiring no outside operating assistance. It is another object of the present invention to provide automatic flow control that discharges floatable debris and does not utilize any external energy source to open or close the controller. It is also an object of the present invention to provide a passive apparatus to catch and retain floatable debris, before being discharged into a receiving body of water, without significantly interfering with the normal discharge flow. It is a further object of the present invention to provide the above functions when the discharge pipe is exposed above the surface of a receiving body of water, submerged below the receiving body of water, or alternately exposed sometimes above the surface and sometimes below the surface of a receiving body of water, for example, in the case of discharge into tidal waters.

### SUMMARY OF THE INVENTION

The present invention provides for a passive flow control valve including a barrier member adapted to attach to a fluid conduit. The barrier member defining an upper portion, a lower portion and an intermediate portion depending from the upper portion and the lower portion. The lower portion and the upper portion each defining an opening therein for allowing fluid to pass therethrough. The intermediate portion defining at least one orifice defined therein, wherein the orifice is configured to allow substantially controlled fluid flow therethrough. The flow control valve may also include a passive arrangement for collecting floatables discharged from a pipe.

The present invention, both as to its construction and its method of operation, together with the additional objects and advantages thereof, will best be understood from the following description of exemplary embodiments when read in connection with the accompanying drawings.

### BRIEF DESCRIPTION OF THE DRAWINGS

FIG. 1A is a front view of a first embodiment according to the present invention during a low flow period;

FIG. 1B is a side sectional view of the first embodiment shown in FIG. 1A;

FIG. 1C is a side sectional view of the first embodiment shown in FIG. 1A during an increased flow period;

FIG. 1D is a side sectional view of the first embodiment shown in FIG. 1A during a maximum flow period;

FIG. 1E is a front view of the first embodiment shown in FIG. 1A having an alternative opening;

FIG. 2A is a front view of a second embodiment according to the present invention during a low flow period;

FIG. 2B is a side sectional view of the second embodiment shown in FIG. 2A;

FIG. 2C is a side sectional view of the second embodiment shown in FIG. 2A during an increased flow period;

FIG. 2D is a side sectional view of the second embodiment shown in FIG. 2A during a maximum flow period;

FIG. 2E is a front view of the second embodiment shown in FIG. 2A having an alternative opening;

FIG. 3A is a front view of a third embodiment according to the present invention;

FIG. 3B is a side sectional view of the third embodiment shown in FIG. 3A;

FIG. 3C is a top plan view of the third embodiment shown in FIG. 3A;

FIG. 3D is a side sectional view of the third embodiment shown in FIG. 3B during a low flow period;

FIG. 3E is a side sectional view of the third embodiment shown in FIG. 3B during an increased flow period;

FIG. 3F is a side sectional view of the third embodiment shown in FIG. 3B during a maximum flow period;

FIG. 3G is a front view of the third embodiment shown in FIG. 3A having an alternative opening;

FIG. 4A is a front view of a fourth embodiment according to the present invention during a low flow period;

FIG. 4B is a side sectional view of the fourth embodiment shown in FIG. 4A;

FIG. 4C is a side sectional view of the fourth embodiment shown in FIG. 4A during an increased flow period;

FIG. 4D is a side sectional view of the fourth embodiment shown in FIG. 4A during a maximum flow period;

FIG. 4E is a front view of the fourth embodiment shown in FIG. 4A having an alternative opening;

FIG. 5A is a front view of a fifth embodiment according to the present invention;

FIG. 5B is a side sectional view of the fifth embodiment shown in FIG. 5A;

FIG. 5C is a top plan view of the fifth embodiment shown in FIG. 5A;

FIG. 5D is a front view of the fifth embodiment shown in FIG. 5A having a catch net attached thereto;

FIG. 5E is a side sectional view of the fifth embodiment shown in FIG. 5D;

FIG. 5F a top plan view of the fifth embodiment shown in FIG. 5D;

FIG. 6A is a front view of a sixth embodiment according to the present invention;

FIG. 6B is a side sectional view of the sixth embodiment shown in FIG. 6A;

FIG. 6C is a top plan view of the sixth embodiment shown in FIG. 6A;

FIG. 6D is a front view of the sixth embodiment shown in FIG. 6A having a catch net attached thereto;

FIG. 6E is a side sectional view of the sixth embodiment shown in FIG. 6D;

FIG. 6F is a top plan view of the sixth embodiment shown in FIG. 6D; and

FIG. 7 is a front view of a seventh embodiment according to the present invention.

### DETAILED DESCRIPTION OF THE PREFERRED EMBODIMENTS

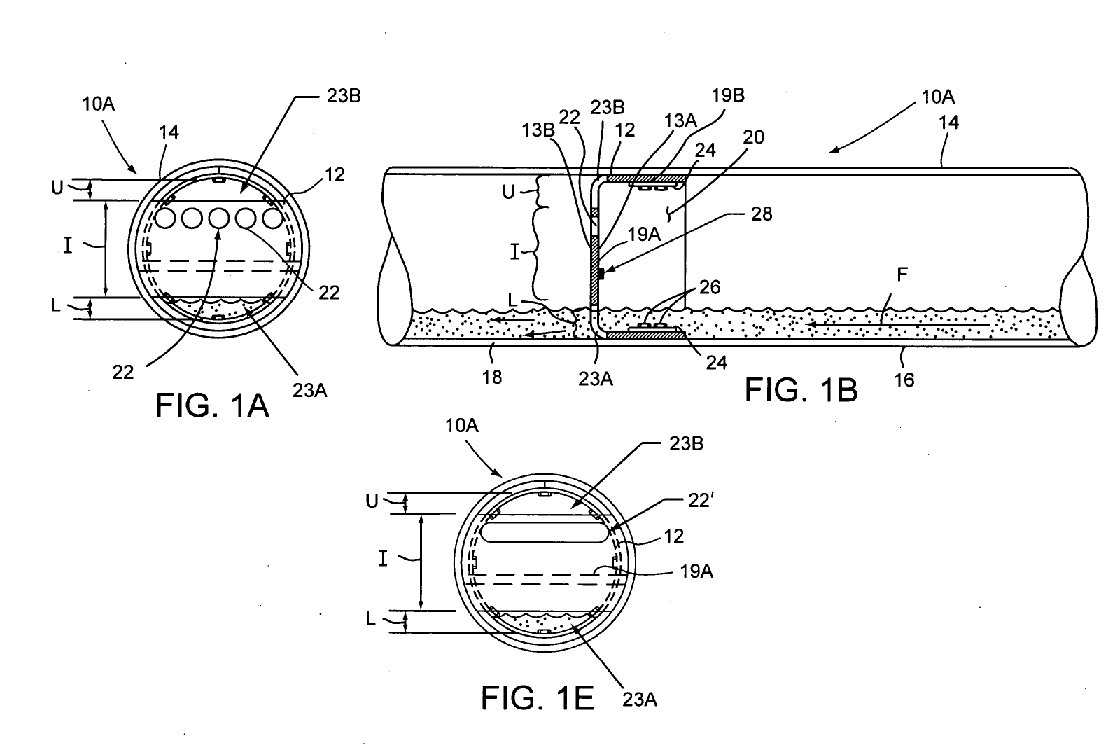

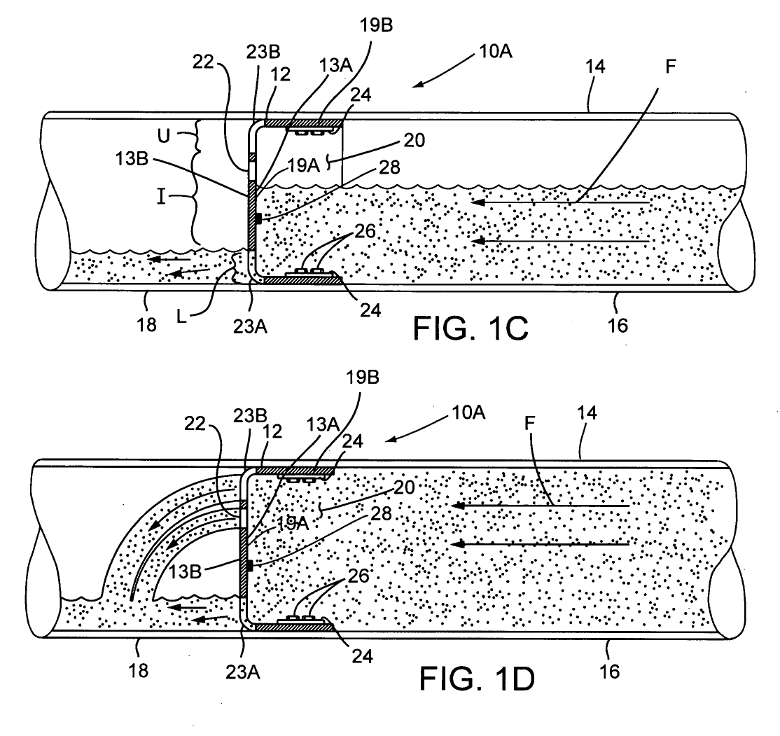

A first embodiment of a flow control valve 10A of the present invention is generally shown in FIGS. 1A-1E. This first embodiment of the flow control valve 10A is particularly adapted to be used in an in-line application in a fluid conduit such as a pipe, for example, a stormwater drainage pipeline. The flow control valve 10A includes a barrier member 12 having a first side 13A and a second side 13B defining an upper portion U, a lower portion L and an intermediate portion I depending from the upper portion U and the lower portion L. The barrier member 12 is positioned inside a pipe 14, essentially separating the pipe 14 into upstream pipeline 16 and downstream pipeline 18. Fluid F, for example stormwater or irrigation water, flows through the upstream pipeline 16, where it eventually encounters the first side 13A of the barrier member 12. In this preferred embodiment, the barrier member 12, which can be cup-shaped, includes a front wall body 19A having an annular portion 19B, wherein the annular portion 19B defines a cavity portion 20 therein. The upstream fluid flowing through the upstream pipeline 16 enters the cavity portion 20 on the first side 13A of the barrier member 12.

Referring to FIGS. 1A-1D, the flow control valve 10A also includes at least one, and preferably more than one, barrier orifice 22 defined in the intermediate portion I of the barrier member 12. These barrier orifices 22 allow controlled fluid flow through the barrier member 12. The flow control valve 10A further includes at least one, and preferably two discharge openings 23A and 23B. The opening 23A is preferably defined in the lower portion L of the barrier member 12 and opening 23B is preferably defined in the upper portion U of the barrier member 12. In this embodiment, a plurality of barrier orifices 22 is positioned substantially on an upper half of the intermediate portion I of the barrier member 12. When fluid flows into the cavity portion 20 of the barrier member 12, the fluid then flows through the opening 23A into the downstream pipeline 18.

As seen in FIG. 1B, during a low flow period, fluid passes from the upstream pipeline 16 through the barrier member 12 via the opening 23A, and into the downstream pipeline 18 with no restriction in the fluid flow. Even with fluids filled with sediment, the opening 23A allows the fluid to pass through with little to no restrictions. However, as shown in FIGS. 1C and 1D, during sudden, increased flow conditions, the barrier member 12 essentially stops high volume, instantaneous fluid flow, allowing only limited and controlled flow through the barrier orifices 22. Thus, for example, a sudden surge of stormwater through the pipe 14 would not adversely impact a stormwater treatment plant located downstream of the flow control valve 10A, since the large volume of fluid is limited and controlled during its flow through the barrier orifices 22.

FIG. 1C illustrates operation of the flow control valve 10A during an increased or high flow period. Even during this high flow period, the flow control valve 10A limits and controls fluid flow to substantially the same level as the low fluid flow of FIG. 1B. The upstream pipeline 16 becomes a storage area for fluid, slowly releasing fluid through the barrier orifices 22. As fluid flow reaches a maximum flow period above barrier orifices 22 as shown in FIG. 1D, fluid is released at a substantially higher rate through opening 23B than through barrier orifices 22, thus preventing fluid backup in the upstream pipeline 16 due to the slow releasing discharge of fluid through the barrier orifices 22 of the barrier member 12. Also, floatable debris, such as leaves, trash or other small floatable objects which may be large enough to block one or more of the barrier orifices 22, may easily pass through opening 23B with little potential for blockage, thus preventing fluid back up in the upstream pipeline 16 cause by floatable debris.

The barrier member 12 may be secured to the pipe 14 with an expandable metal band 24. This expandable metal band 24 may be secured directly to the walls or inner surface of the pipe 14 with, for example, a bolt arrangement 26. It is preferable to secure the annular portion 19B of the barrier member 12 to ensure rigidity. At least one rib 28 is provided on the first side 13A of the intermediate portion I of the barrier member 12, such that the rib 28 may be attached to, or integrally formed with the barrier member 12. In this embodiment, the rib 28 runs substantially across the first side 13A of the barrier member 12, providing overall support to the barrier member 12. The rib 28 may be made with support rubber having a high durometer (approximately 90 Shore A) and reinforcing ply fabric, with at least one ply and, in many cases, multiple plies. The rib 28 assists the barrier member 12 in holding the weight of the tremendous volume of fluid in the upstream pipeline 16. It is also envisioned that there may be a plurality of ribs 28 (not shown) and that external metal ribs may be used to provide such support.

It will be apparent to those skilled in the art that the barrier orifices 22 and openings 23A and 23B, may be sized smaller or larger, as required, for the desired drainage rate and to prevent blockage by solid objects or floatable debris which may be present in the fluid flow. The openings 23A and 23B are preferably shaped corresponding to the shape of the drainage pipe. For example, a circular pipe will preferably have sector shaped openings 23A and 23B in the barrier member 12. It is further envisioned that the number of barrier orifices 22 may be varied according to the fluid flow needs of a particular application. In addition, these barrier orifices 22 may be any geometric shape such as round, oval or any other suitable shape. For example, FIG. 1E shows a barrier member 12 having a single elongated orifice or slot 22′ therein instead of a plurality of barrier orifices 22. A single large orifice can be advantageous in situations where debris, such as rags, may clog one or more of the smaller multiple openings.

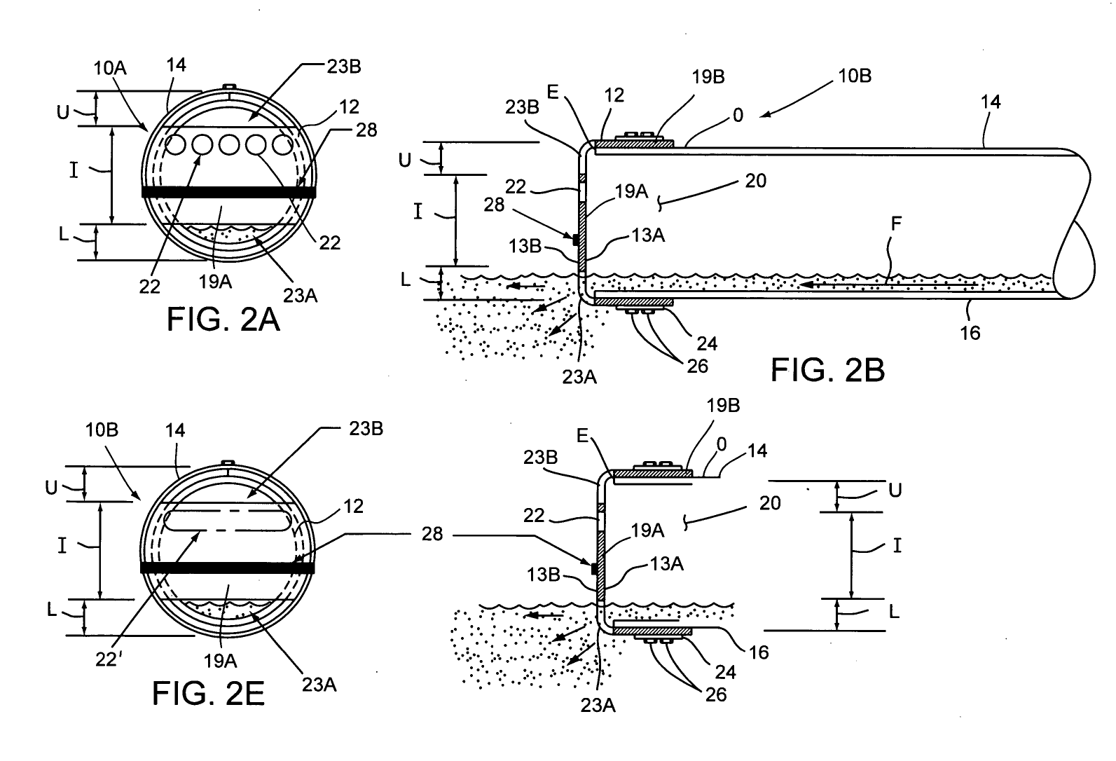

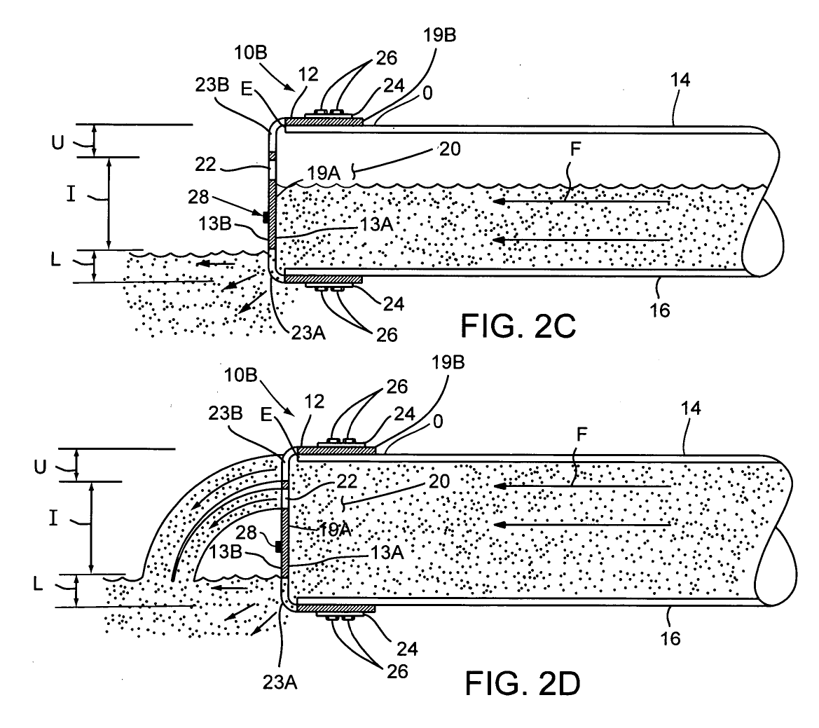

FIGS. 2A-2E show a second embodiment of a flow control valve 10B of the present invention that is similar to control valve 10A. Like reference numerals are used for like parts. In this embodiment, the barrier member 12 is positioned at an end E of the pipe 14, essentially providing flow control as fluid exits the pipe 14. Here, the cavity portion 20 of the barrier member 12 receives the end E of the pipe 14 and a metal band 24 is used to secure the barrier member 12 directly to an outer surface O of the pipe 14 via a bolt arrangement 26. With this external mounting of the control valve 10A, the size of the openings 23A and 23B can be increased by increasing the length of the control valve 10A. The openings 23A and 23B can thereby be increased to be equal to, or greater than, an open area of the pipe 14, thereby allowing full maximum flow with high upstream fluid levels. At least one rib 28 may also be provided on the second side 13B of the barrier member 12, thus providing overall support to the barrier member 12. FIG. 2E shows the barrier member 12 having an elongated slot 22′ therein instead of a plurality of barrier orifices 22.

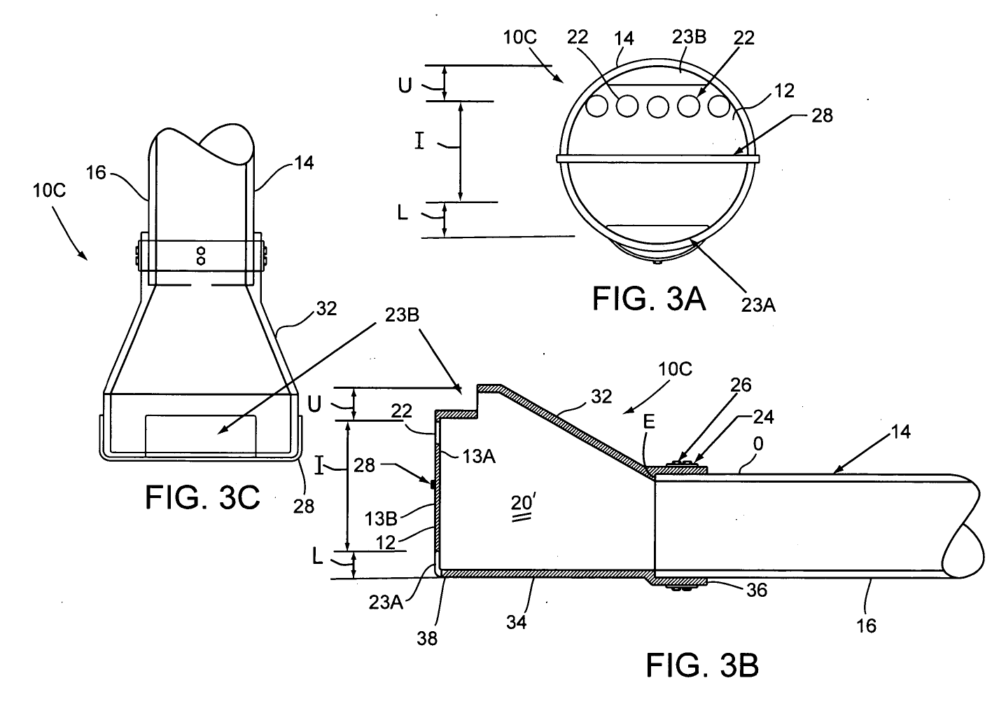

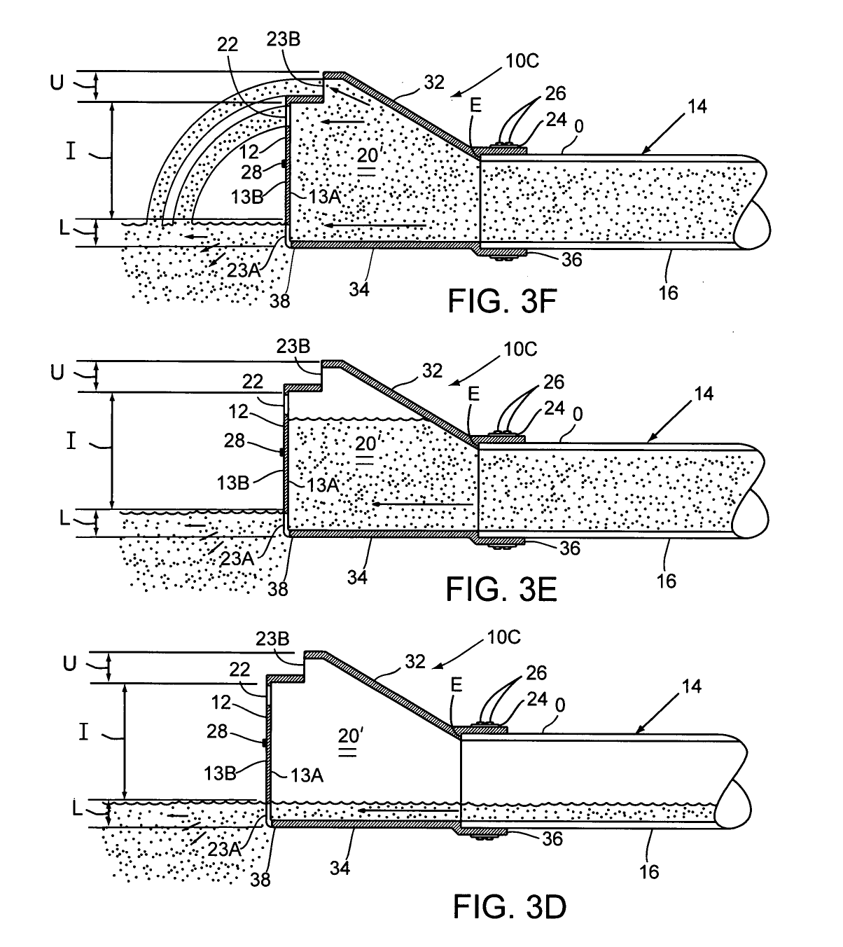

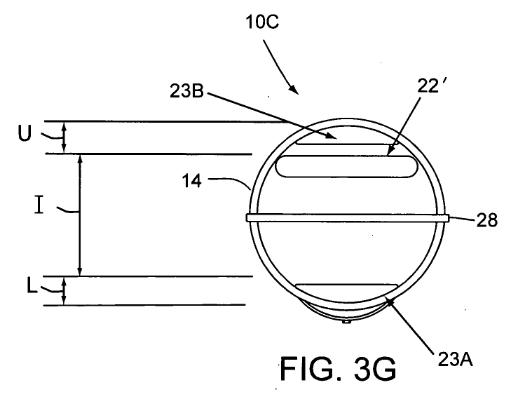

A third embodiment of a flow control valve 10C of the present invention is generally shown in FIGS. 3A-3G. The flow control valve 10C is similar to the flow control valve 10B, except that the cup-shaped barrier member 12 is replaced with an extendable barrier chute 32 attached to an end E of a pipe 14. Like reference numerals are used for like parts. The chute 32 includes a longitudinal extending body 34 having an open first end portion 36 and a second end portion 38, thus defining an enlarged cavity portion 20′ therein. The first end portion 36 is configured to be attached to an outer surface O of the pipe 14 in a similar manner as barrier member 12 is attached in flow control valve 10B shown in FIG. 2B. The second end portion 38 includes a barrier member 12 defining an upper portion U, a lower portion L and an intermediate portion I depending from the upper portion U and the lower portion L for controlling the fluid flow exiting the pipe 14. The diameter of the chute 32 increases from the first end portion 36 to the second end portion 38, such that a greater volume of fluid may be discharged from the second end portion 38 of the body 34. The barrier member 12 having a first side 13A and a second side 13B on the second end portion 38 of the chute 32 includes a plurality of barrier orifices 22 arranged on an upper half of the intermediate portion I, two discharge openings 23A and 23B each positioned on the lower portion L and the upper portion U, respectively, and at least one rib 28 provided on the second side 13B of the intermediate portion I of the barrier member 12. Opening 23B is preferably larger than opening 23A for allowing substantial amounts of fluid to pass through during maximum flow periods along with allowing larger floatable debris to pass through. FIG. 3G shows the barrier member 12 on the second end portion 38 of the chute 32 having a single elongated orifice or slot 22′ therein instead of a plurality of barrier orifices 22.

FIGS. 3D-3F illustrate the operation of the flow control valve 10C during low flow periods, high flow periods and maximum flow periods. The overall flow characteristics of this embodiment are unchanged from those of the first and second embodiments of the present invention.

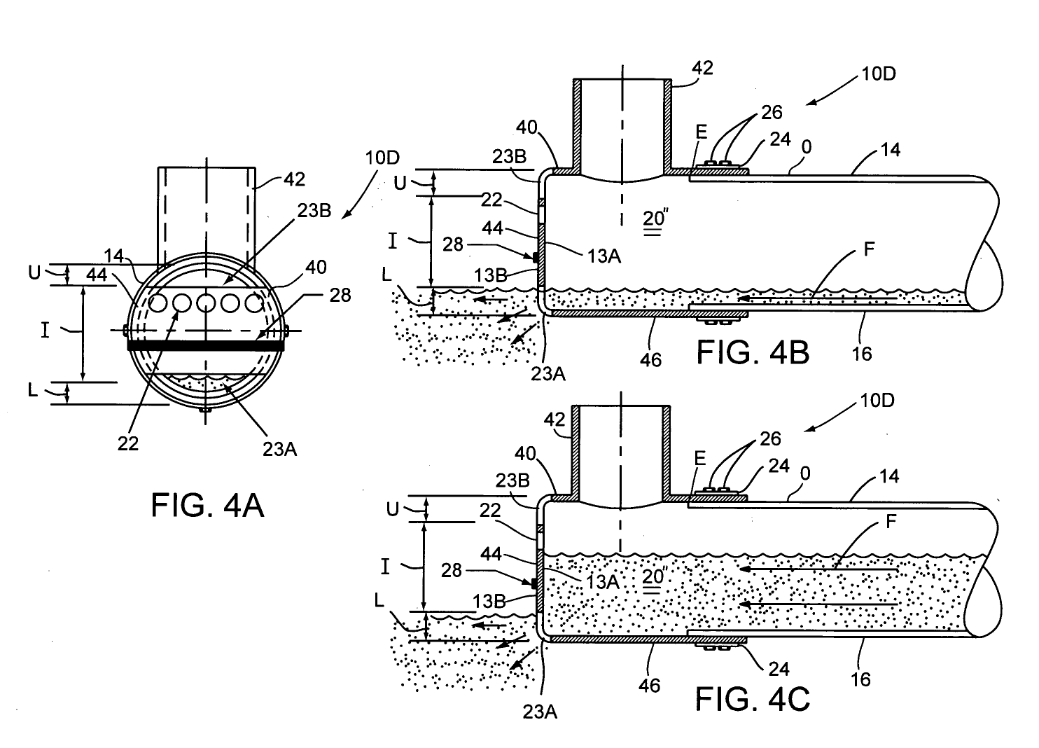

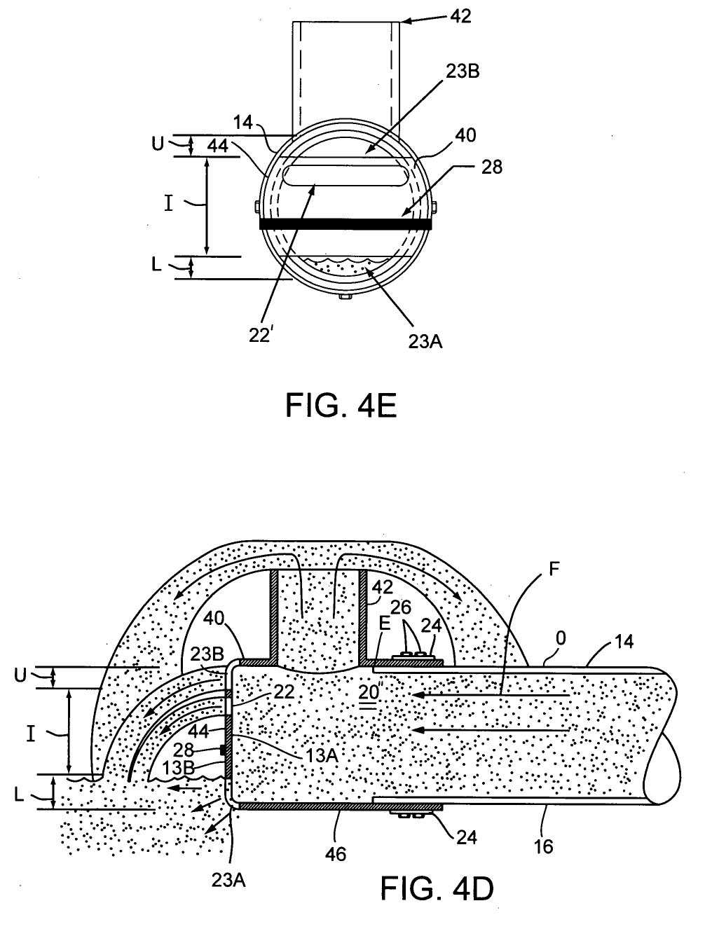

FIGS. 4A-4E show a fourth embodiment of a flow control valve 10D of the present invention that is similar to control valve 10B. Like reference numerals are used for like parts. The control valve 10D includes an elongated barrier member 40 attached to an end E of a pipe 14 that is similar to the cup-shaped barrier member 12 in flow control valve 10B, except that a passageway such as an overflow pipe 42 is fluidly connected to the elongated barrier member 40. Specifically, the barrier member 40 includes a front wall body 44 and an elongated annular portion 46 extending laterally from the front wall body 44, wherein the annular portion 46 defines a cavity portion 20” therein. The elongated annular portion 46 of the barrier member 40 is attached to the outer surface O of the pipe 14 in a similar manner as barrier member 12 is attached to control valve 10B shown in FIG. 2B. The front wall body 44 of control valve 10D is the same as the body 19A of the barrier member 12 in control valve 10B and includes openings 23A and 23B, rib 28 and barrier orifices 22. The overflow pipe 42 is fluidly connected to the elongated annular portion 46 of the barrier member 40 and extends laterally therefrom. The overflow pipe 42 allows additional fluid to discharge at a higher elevation than at the top of the pipe 14. The overflow pipe 42 may be any length necessary to conform to the application requirements. For example, typical lengths of the overflow pipe 42 can range from several inches to six feet. These larger lengths allow fluid to back-up further in the pipe 14 thus storing more fluid. FIG. 4E shows the front wall body 44 of the barrier member 40 having an elongated orifice or slot 22′ therein instead of a plurality of barrier orifices 22.

FIGS. 4B-4D show the operation of the flow control valve 10D in which fluid is released through the overflow pipe 42, when the openings 23A, 23B and barrier orifices 22 cannot discharge the fluid fast enough due to a storm surge or other conditions that cause maximum fluid flow as shown in FIG. 4D.

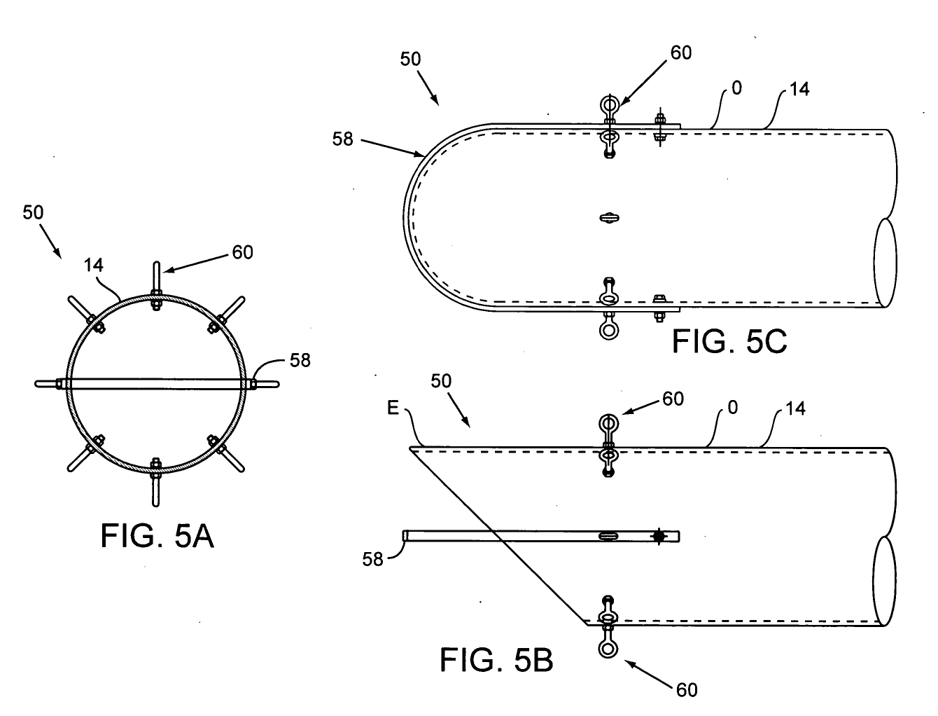

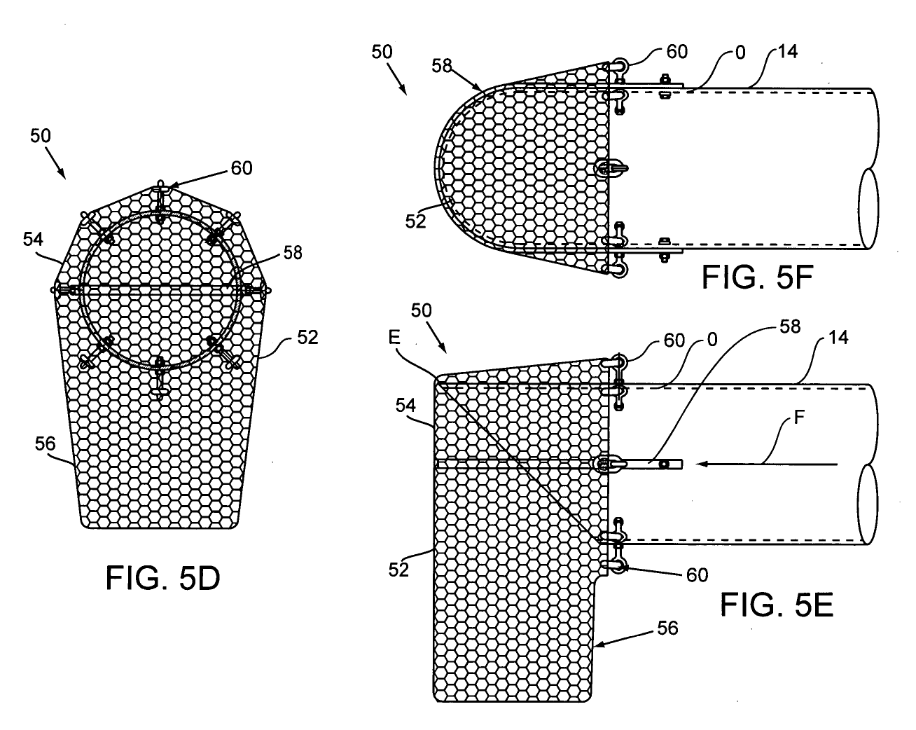

FIGS. 5A-5F show a fifth embodiment of the present invention that includes an arrangement 50 for collecting floatables discharged from a pipe 14, typically in applications where the pipe 14 is above the level of a receiving body of water. Referring to FIGS. 5D-5F, the arrangement 50 includes a porous member 52, such as a catch net or cage, having a first portion 54 and a second portion 56 and a net support 58 attached to a pipe 14. In this embodiment, a catch net 52 is attached to the outer surface O of the pipe 14 via a clamp arrangement 60 such as the use of eyebolts assembled on the end E of the pipe 14 along with snap clips used to fasten the catch net 52 to the eyebolts as shown in FIGS. 5D-5F. An end E of the pipe 14 is preferably angled, wherein the first portion 54 of the catch net 52 is supported by the pipe 14. The net support 58 defines an elongated body bent to form a U-shaped member or bar wherein each end is attached to a middle portion of the pipe 14 and extends away from the end E of the pipe 14. In an alternative configuration for smaller sized pipes, the net support 58 can also be molded as an integral part of the end E of the pipe 14 (not shown). The net support 58 supports or holds the catch net 52 in order to keep the member 52 in an expanded or open position such that the second portion 56 of the catch net 52 hangs or extends below the pipe 14 in an open position. The net support 58 can be made of metal, plastic, wood or other material suited to the application. The porous member 52 can be made of metal, plastic, cloth, rubber or other material suitable for the application. The porous member 52 can be rigid (cage), semi flexible or supple (net), such as nylon or other fibrous material. The porous member 52 can be substantially larger in surface area than the opening of the discharge pipe 14. The eyebolts and quick disconnect snap clips of the clamp arrangement 60 are merely to illustrate a typical method of attachment, as other removable attachment means are equally well suited and are contemplated by this invention.

In operation, the flow discharges through the end E of the pipe 14 and passes through the porous member 52, essentially unrestricted. Any floatables are collected in the second (lower) portion 56 of the porous member 52 out of the path of the normal flow. The porous member 52 is configured to allow collection and storage of floatables without interfering with the normal flow discharge. The floatables are later removed for appropriate disposal.

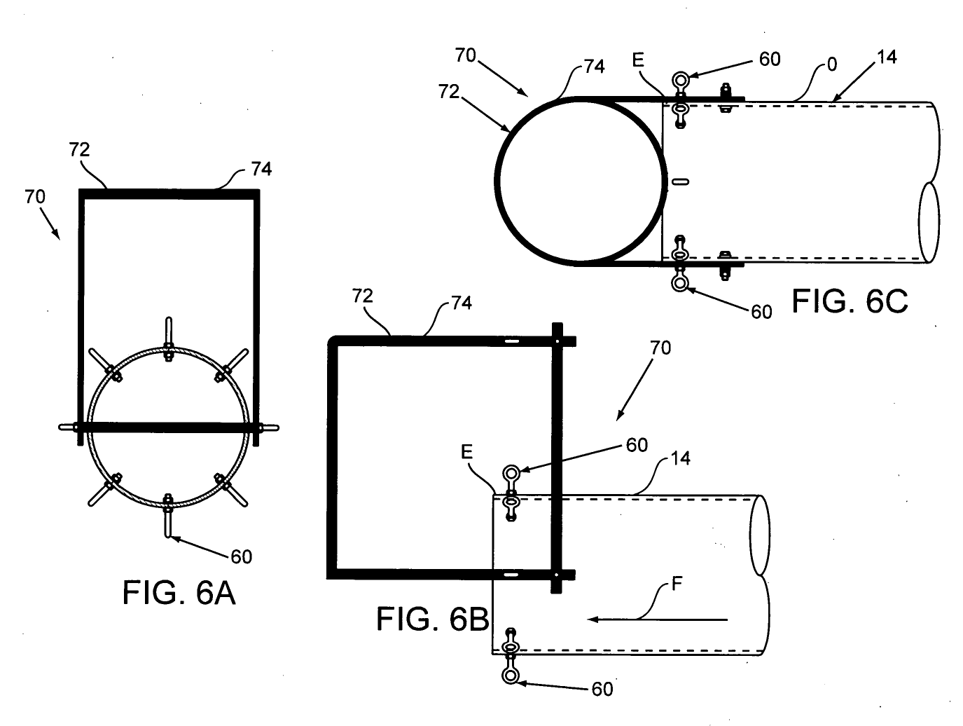

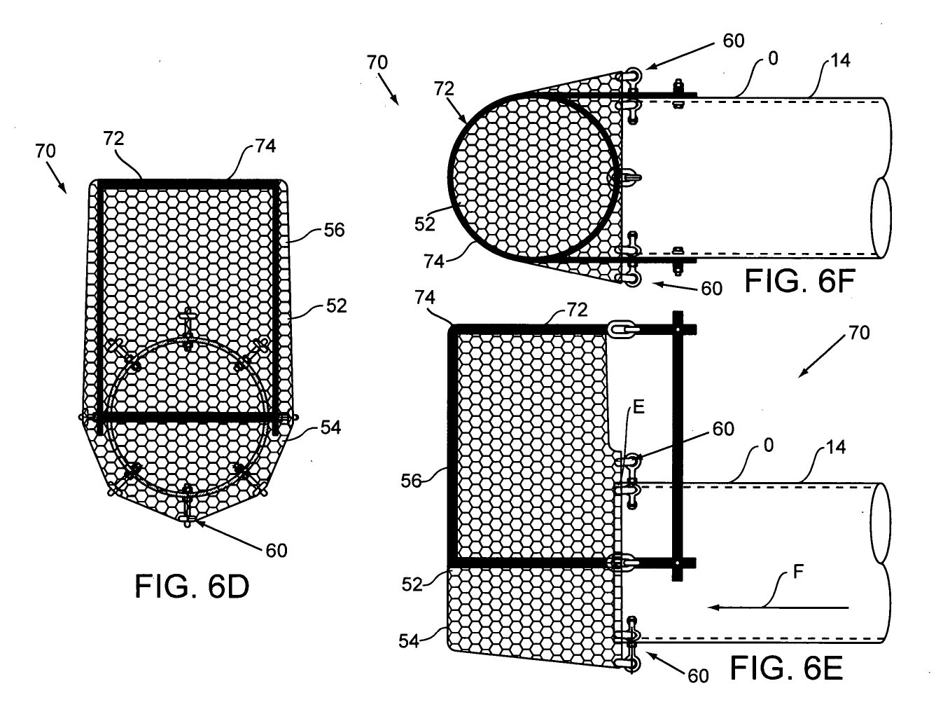

FIGS. 6A-6F show a sixth embodiment of an arrangement 70 for collecting floatables discharged from a pipe 14, typically in applications where the pipe 14 is below the level of a receiving body of water. Arrangement 70 is similar to arrangement 50 except for the differences noted below. Like reference numerals are used for like parts. In this embodiment, the arrangement 70 includes a robust support member 72 for holding a catch net 52 in an open position above the pipe 14. The member 72 includes a box-shaped frame 74 attached to a middle portion of the pipe 14, wherein the frame 74 extends above and away from an end E of the pipe 14. In an alternative configuration for smaller sized pipes, the frame 74 can also be molded as an integral part of the end E of the pipe 14 (not shown). The catch net 52 is supported by the frame 74, wherein the second portion 56 of the catch net 52 extends above the pipe 14 and is held in an open position. The shape of the frame 74 corresponds to the shape of the catch net 52 in an open position. The catch net 52 is attached to the pipe 14 in the same manner as in the fifth embodiment of the present invention.

In operation, the flow discharges through the end E of the pipe 14 and passes through the porous member 52, essentially unrestricted. Any floatables float upward and are collected in the second (upper) portion 56 of the porous member 52 out of the path of the normal flow. The floatables are later removed for appropriate disposal.

In situations where the receiving body of water varies in level both below and above the discharge pipe 14, such as discharge into a tidal body of water, a combination of the embodiments of FIGS. 5A-5F and FIGS. 6A-6F can be used to provide essentially unrestricted flow under all conditions.

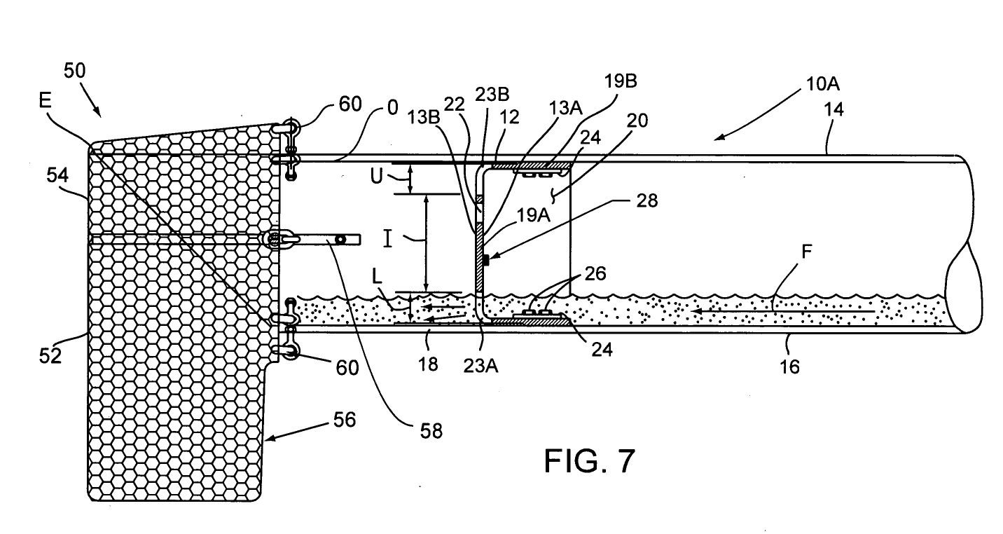

FIG. 7 shows a seventh embodiment of the present invention 80 that includes an arrangement 50 for collecting floatables discharged from a pipe 14 used in conjunction with flow control valve 10A. Further, the arrangements 50 and 70 for catching floatable debris may also be used in conjunction with any of the flow control valves 10A-10D.

Overall, the flow control valves 10A-10D of the present invention are completely passive control systems which require no outside assistance to operate. There is no need for an operator to go out in the height of a storm to operate the present invention. The flow control valves 10A-10D automatically provide reduced flow after a storm, and return to normal flow during normal flow conditions. It is important to note that, while the present invention has been described only as to stormwater and irrigation applications, the present invention is also applicable and useful in other pipeline or drainage ditch applications that require passive flow control.

This invention has been described with reference to the preferred embodiments. Obvious modifications and alterations will occur to others upon reading and understanding the preceding detailed description. It is intended that the invention be construed as including all such modifications and alterations.

I claim:

1. A passive flow control valve, comprising:
a barrier member adapted to attach to a fluid conduit, said barrier member defining an upper portion, a lower portion and an intermediate portion depending from said upper portion and said lower portion, said lower portion and said upper portion each defining an opening therein for allowing fluid to pass therethrough, said intermediate portion defining at least one orifice defined therein, wherein the orifice is configured to allow substantially controlled fluid flow therethrough.

2. The passive flow control valve of claim 1, wherein said barrier member comprises a body having an annular portion, said annular portion defining a cavity therein.

3. The passive flow control valve of claim 2, wherein said annular portion of said body of said barrier member is configured to be attached to an inner surface of a fluid conduit.

4. The passive flow control valve of claim 2, wherein said annular portion of said body of said barrier member is configured to be attached to an outer surface of a fluid conduit.

5. The passive flow control valve of claim 1, wherein said intermediate portion of said barrier member further defines a plurality of orifices.

6. The passive flow control valve of claim 1, wherein the orifice is geometric shaped.

7. The passive flow control valve of claim 1, wherein said intermediate portion of said barrier member comprises a single elongated orifice.

8. The passive flow control valve of claim 2, wherein said annular portion comprises a passageway extending laterally away from said upper portion of said barrier member, the passageway adapted to allow additional fluid to discharge during maximum flow conditions.

9. The passive flow control valve of claim 2, wherein said upper portion of said barrier member further comprises a second conduit fluidly connected to said annular portion and extending laterally therefrom.

10. The passive flow control valve of claim 1, further comprising a rib attached to said intermediate portion for providing additional support to said barrier member.

11. The passive flow control valve of claim 1, wherein:
said lower portion of said barrier member comprises a first opening defined therein, the first opening, at least during normal flow conditions, adapted to allow fluid to pass through with little to no restriction of flow; and
said upper portion of said barrier member comprises a second opening defined therein, the second opening, at least during maximum flow conditions, adapted to allow fluid to pass through at a substantial-rate with little or no blockage of the second opening due to floatable debris.

12. The passive flow control valve of claim 11, wherein the opening in both said upper portion and said lower portion of said barrier member corresponds to the shape of the fluid conduit.

13. The passive flow control valve of claim 12, wherein the opening in both said upper portion and said lower portion of said barrier member are sector shaped.

14. A passive flow control valve, comprising:
an extendable barrier chute adapted to attach to a fluid conduit, said barrier chute comprises a longitudinal extending body having an open first end portion and a second end portion and defining a cavity portion therein, the first end portion configured to attach to a fluid conduit, the second end portion comprises a barrier member having an upper portion, a lower portion and an intermediate portion depending from said upper portion and said lower portion; said lower portion and said upper portion each defining an opening therein for allowing fluid to pass therethrough, said intermediate portion defining at least one orifice defined therein, wherein the orifice is configured to allow substantially controlled fluid flow therethrough.

15. The passive flow control valve of claim 14, wherein said intermediate portion of said barrier member comprises a single elongated orifice.

16. The passive flow control valve of claim 14, wherein:
said lower portion of said barrier member comprises a first opening defined therein, the first opening, at least during normal flow conditions, adapted to allow fluid to pass through with little to no restriction of flow; and
said upper portion of said barrier member comprises a second opening defined therein, the second opening is larger than the first opening such that, at least during maximum flow conditions, the second opening is adapted to allow fluid to pass through at a substantial rate with little or no blockage of the second opening due to floatable debris.

17. The passive flow control valve of claim 14, further comprising a rib attached to said intermediate portion for providing additional support to said barrier member.

18. An arrangement for collecting floatables discharged from a fluid conduit, the arrangement comprising:
a porous member having a first portion and a second portion adapted to be removably attached to a conduit;
a support member adapted to be attached to said conduit and extending therefrom, wherein said support member is configured to hold said porous member in an expanded position away from said conduit.

19. The arrangement of claim 18, wherein the support member is a U-shaped bar, and wherein said bar is configured to hold said porous member in an expanded position such that said second portion of said porous member extends below said conduit.

20. The arrangement of claim 19, wherein said conduit is angled at an end such that said end of said conduit is configured to support said first portion of said porous member.

21. The arrangement of claim 18, wherein the support member is a box-shaped frame extending outwardly and upwardly from said conduit, and wherein said frame is configured to hold said porous member in an expanded position such that said second portion of said porous member extends above said conduit.

22. The arrangement of claim 18, wherein the porous member is removably attached to said conduit via a clamp arrangement such as eyebolts used in combination with snap clips.

23. The arrangement of claim 18, wherein the porous member comprises a net or cage.

24. A passive flow control valve assembly, comprising:
a fluid conduit;
a barrier member adapted to attach to said conduit, said barrier member defining an upper portion, a lower portion and an intermediate portion depending from said upper portion and said lower portion, said lower portion and said upper portion each defining an opening therein for allowing fluid to pass therethrough, said intermediate portion defining at least one orifice defined therein, wherein the orifice is configured to allow substantially controlled fluid flow therethrough;
a porous member having a first portion and a second portion removably attached to an end of said conduit; and
a support member attached to said conduit and extending therefrom, wherein said support member coacts with said porous member to hold said porous member in an expanded position away from said conduit.
